(19) United States
(12) Patent Application Publication
(10) Pub. No.: US 2026/0230502 A1
(43) Pub. Date: Aug. 6, 2026

(54) PHISHING EVENT DETECTION

(71) Applicant: OKTA, INC., SAN FRANCISCO, CA (US)

(72) Inventors: Fei Liu, Cupertino, CA (US); Moussa Diallo, Paris (FR); Yu Liu, San Carlos, CA (US); Todd McKinnon, San Francisco, CA (US)

(21) Appl. No.: 19/043,267

(22) Filed: Jan. 31, 2025

(51) Int. Cl. H04L 9/40; H04L 41/16

(52) U.S. Cl. CPC H04L 63/1483; H04L 41/16; H04L 63/1416

(57) ABSTRACT

A security system may performing phishing protection operations using a model that is trained on attributes extracted from phishing events. For example, the security system may receive a request to access a resource of a uniform resource locator (URL) using a credential of a user of an organization. The security system may categorize the request to access the resource of the URL as a phishing event. Based on categorizing the request as the phishing event, the security system may extract one or more attributes from the phishing event. The security system may perform, in real-time, at least one first phishing protection operation that is in accordance with the extracted one or more attributes. Additionally, the security system may perform at least one second phishing protection operation that is in accordance with an output of a model of the security system that is trained using the one or more attributes.

### FIELD OF TECHNOLOGY

The present disclosure relates generally to security systems and authentication, and more specifically to phishing event detection, prevention, and response.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials.

### SUMMARY

A method for phishing event detection by an apparatus is described. The method may include receiving, at a security system, a request to access a resource of a uniform resource locator (URL) using a credential of a user of an organization, categorizing the request to access the resource of the URL as a phishing event, extracting one or more attributes from the phishing event based on categorizing the request as a phishing event, performing, in real-time, at least one first phishing protection operation that is in accordance with the extracted one or more attributes, and performing at least one second phishing protection operation that is in accordance with an output of a model of the security system that is trained using the one or more attributes.

An apparatus for phishing event detection is described. The apparatus may include one or more memories storing processor executable code, and one or more processors coupled with the one or more memories. The one or more processors may individually or collectively be operable to execute the code to cause the apparatus to receive, at a security system, a request to access a resource of a URL using a credential of a user of an organization, categorize the request to access the resource of the URL as a phishing event, extract one or more attributes from the phishing event based on categorizing the request as a phishing event, perform, in real-time, at least one first phishing protection operation that is in accordance with the extracted one or more attributes, and perform at least one second phishing protection operation that is in accordance with an output of a model of the security system that is trained using the one or more attributes.

Another apparatus for phishing event detection is described. The apparatus may include means for receiving, at a security system, a request to access a resource of a URL using a credential of a user of an organization, means for categorizing the request to access the resource of the URL as a phishing event, means for extracting one or more attributes from the phishing event based on categorizing the request as a phishing event, means for performing, in real-time, at least one first phishing protection operation that is in accordance with the extracted one or more attributes, and means for performing at least one second phishing protection operation that is in accordance with an output of a model of the security system that is trained using the one or more attributes.

A non-transitory computer-readable medium storing code for phishing event detection is described. The code may include instructions executable by one or more processors to receive, at a security system, a request to access a resource of a URL using a credential of a user of an organization, categorize the request to access the resource of the URL as a phishing event, extract one or more attributes from the phishing event based on categorizing the request as a phishing event, perform, in real-time, at least one first phishing protection operation that is in accordance with the extracted one or more attributes, and perform at least one second phishing protection operation that is in accordance with an output of a model of the security system that is trained using the one or more attributes.

Some examples of the method, apparatus, and non-transitory computer-readable medium described herein may further include operations, features, means, or instructions for generating, via the model of the security system, one or more heuristic rules that define whether an event includes a phishing event, where applying the at least one second phishing protection operation includes applying the one or more heuristic rules.

Some examples of the method, apparatus, and non-transitory computer-readable medium described herein may further include operations, features, means, or instructions for performing the at least one first phishing protection operation includes detecting one or more phishing events in accordance with one or more incoming requests received at the security system, the one or more incoming requests having the one or more attributes extracted from the phishing event.

Some examples of the method, apparatus, and non-transitory computer-readable medium described herein may further include operations, features, means, or instructions for designating the one or more attributes as positive examples of phishing events and training the model of the security system using the one or more attributes designated as positive examples of phishing events.

Some examples of the method, apparatus, and non-transitory computer-readable medium described herein may further include operations, features, means, or instructions for generating the model of the security system using the extracted one or more attributes.

In some examples of the method, apparatus, and non-transitory computer-readable medium described herein, the URL may be absent from a set of URLs permitted for the organization and the request may be categorized as the phishing event based on the URL being absent from the set of URLs.

Some examples of the method, apparatus, and non-transitory computer-readable medium described herein may further include operations, features, means, or instructions for receiving a user input indicating that the URL may be unused by the organization, a security team, or both and updating a set of malicious URLs to include the URL based on the user input, where extracting the one or more attributes from the phishing event may be further based on updating the set of malicious URLs to include the URL.

Some examples of the method, apparatus, and non-transitory computer-readable medium described herein may further include operations, features, means, or instructions for receiving a second request to access a second resource of a second URL using the credential of the user of the organization.

Some examples of the method, apparatus, and non-transitory computer-readable medium described herein may further include operations, features, means, or instructions for determining that the second URL may be included in a set of URLs permitted for the organization and processing the request to access the resource of the URL after determining that the second URL may be included in the set of URLs.

Some examples of the method, apparatus, and non-transitory computer-readable medium described herein may further include operations, features, means, or instructions for determining that the second URL may be absent from a set of URLs permitted for the organization, receiving a user input indicating that the second URL may be used by the organization, a security team, or both, and updating the set of URLs permitted for the organization to include the second URL.

In some examples of the method, apparatus, and non-transitory computer-readable medium described herein, the one or more phishing event attributes include one or more of a timestamp of the request, the URL, an internet protocol (IP) address of a user device that transmitted the request, an identifier of the organization, an identifier of the user, or an identifier of an actor, and the one or more phishing flow attributes include one or more devices involved in a flow, one or more IP addresses involved in the flow, or both.

In some examples of the method, apparatus, and non-transitory computer-readable medium described herein, the model includes an artificial intelligence (AI) or machine learning (ML) model.

### BRIEF DESCRIPTION OF THE DRAWINGS

FIG. 1 illustrates an example of a computing system that supports phishing event detection in accordance with aspects of the present disclosure.

FIG. 2 shows an example of a security system that supports phishing event detection in accordance with aspects of the present disclosure.

FIG. 3 shows an example of a process flow that supports phishing event detection in accordance with aspects of the present disclosure.

FIG. 4 shows a block diagram of an apparatus that supports phishing event detection in accordance with aspects of the present disclosure.

FIG. 5 shows a block diagram of a phishing detection component that supports phishing event detection in accordance with aspects of the present disclosure.

FIG. 6 shows a diagram of a system including a device that supports phishing event detection in accordance with aspects of the present disclosure.

FIGS. 7 and 8 show flowcharts illustrating methods that support phishing event detection in accordance with aspects of the present disclosure.

### DETAILED DESCRIPTION

Security systems may implement various techniques to protect identities of users and block malicious activities. In some cases, these techniques may involve a determination of boundaries or thresholds that define “malicious” activities. For example, a security system may determine that a threshold quantity of attempts to provide a correct password in a duration from a same internet protocol (IP) address is indicative of a malicious activity. Boundaries or thresholds defining malicious activities may be based on aggregated data related to sign-in activity across users of the security system. However, the boundaries or thresholds may be set arbitrarily, as the security system may not store information about activities that are identified as malicious. That is, security systems, such as identity management systems, may block activity that is identified as malicious without storing information about the activity and, accordingly, information about activities that are identified as malicious may be unavailable.

Additionally, the security systems may, in some cases, incorrectly identify activity as malicious. For example, a legitimate user may incorrectly provide their password a quantity of times, meeting the threshold quantity of attempts and thereby identifying the user's attempt to sign in as allegedly malicious activity. That is, because the boundaries or thresholds that define malicious activity are set somewhat arbitrarily, normal, non-malicious activity may fall within boundaries or thresholds for the malicious activity. When a security system is unsure about whether an activity is malicious (e.g., when activities are incorrectly identified as malicious), the security system may be limited in extracting indicators of compromise (IOCs) with high confidence levels and in training models using information about malicious activity.

One example of malicious activity may be phishing events. As used herein, a phishing event may refer to attempted or successful access to a resource of a uniform resource locator (URL) or via the URL, where the URL is illegitimate and used to maliciously obtain user information. In some examples, the URL may be provided via a phishing email, short message service (SMS), or some other embedding that is accessible by a user. The user of the organization may attempt to sign in at the URL using their credential and via the security system, such as an identity management system. If the user accesses the URL, they may provide their credentials or other sensitive information to an attacker or, in some cases, subject their device to installation of malware. Accordingly, the security system may define one or more URLs as being malicious and one or more other URLs as permissible. However, users may attempt to access URLs that are not defined by the security system as malicious or permissible and, thus the security system may arbitrarily identify whether newly identified URLs are part of a phishing event.

Techniques described herein support improved recordation and storage of information about malicious activities, as well as use of that information about malicious activities to improve accuracy of malicious activity detection. Specifically, techniques described herein relate to improved detection of phishing events. For example, a security system may identify phishing events by categorizing URLs as being malicious or permissible. In some examples, the security system may categorize the URLs by obtaining one or more user inputs that indicate whether the URLs are used by an organization. When a URL is categorized as malicious, the security system may extract attributes associated with a request to access the URL. For example, the security system may determine that an event (e.g., a request to access the URL) is a phishing event based on the URL being categorized as malicious and extract information about that phishing event.

The security system may apply the extracted information to improve phishing detection in real-time and using a model. For example, the security system may perform a phishing protection operation in real-time (e.g., blocking an incoming malicious request immediately after extraction of the attributes). Additionally, the security system may use the attributes as input to the model, to train the model, to generate the model, or the like. The security system may use the model to generate phishing protection operations that are subsequently applied. Accordingly, the security system may improve detection of phishing events by using extracted attributes of identified phishing events to apply phishing protection operations both in real-time and based on outputs of a model that is trained to output policies that accurately distinguish phishing activity from non-malicious activity.

Aspects of the disclosure are initially described in the context of a computing system. Aspects of the disclosure are also described in the context of a security system and a process flow. Aspects of the disclosure are further illustrated by and described with reference to apparatus diagrams, system diagrams, and flowcharts that relate to phishing event detection.

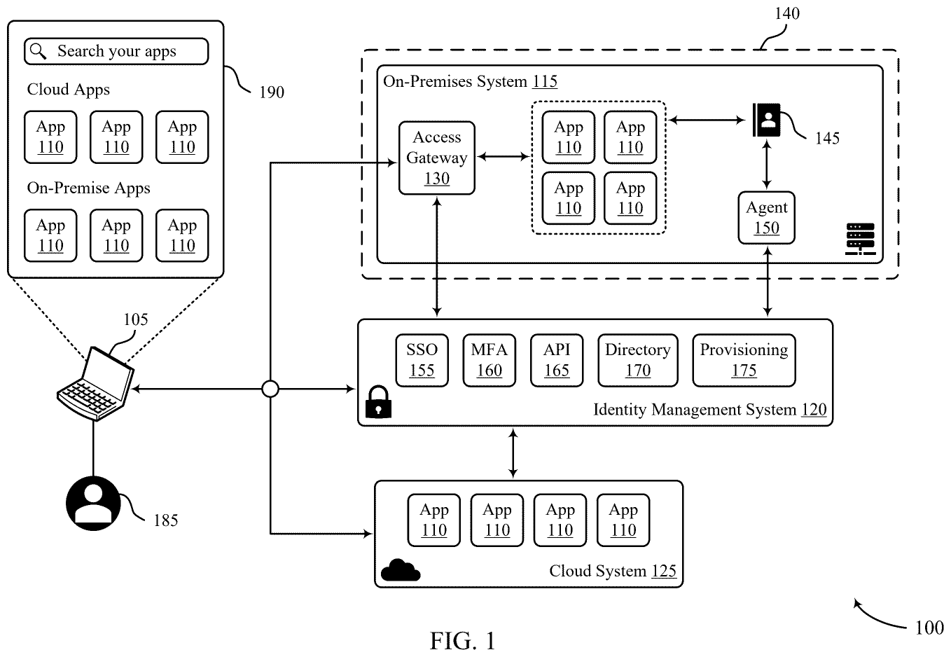

FIG. 1 illustrates an example of a computing system 100 that supports phishing event detection in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as a single sign-on (SSO) service 155, a multi-factor authentication (MFA) service 160, an application programming interface (API) service 165, a directory management service 170, or a provisioning service 175 for various on-premises applications 110 (e.g., applications 110 running on compute resources of the on-premises system 115) and/or cloud applications 110 (e.g., applications 110 running on compute resources of the cloud system 125), among other examples of services. The SSO service 155, the MFA service 160, the API service 165, the directory management service 170, and/or the provisioning service 175 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 to communicate with one or more of the on-premises system 115, the identity management system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the computing device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user's request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user's request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user's identity by comparing the credentials provided by the user 185 to credentials associated with the user's account. For example, one or more credentials associated with the user's account may be registered with the IdP (e.g., previously registered, or otherwise authorized for authentication of the user's identity via the IdP). The IdP may generate a security token (such as a SAML token or Oath 2.0 token) containing information associated with the identity and/or authentication status of the user 185 based on successful authentication of the user's identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185) to interact with a client organization's APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee's accounts and revoke the employee's access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

The identity management system 120 may detect malicious activity, including phishing events. For example, the user 185 may attempt to access a resource of a URL using a credential authorized by identity management system 120. The identity management system 120 may use stored information about phishing events to accurately identify incoming requests as being malicious (e.g., as being phishing events) or non-malicious (e.g., normal user activity). For example, the identity management system 120 may apply extracted attributes from previously detected phishing events to improve identification of phishing events for the incoming requests. That is, if an incoming request to access a URL has attributes that match attributes of a previously detected phishing event, the identity management system 120 may block access to the URL. Additionally, or alternatively, the identity management system 120 may use the extracted attributes from the previously detected phishing events to generate, train, or as input to a model, such as an AI or ML model. For example, the model may output policy recommendations that may be applied to more accurately identify phishing events, identify whether incoming requests are phishing events, or the like. By using the extracted attributes from previously identified phishing events, techniques described herein support improved identification of phishing events, leading to improved user experience related to reduction of falsely identifying user behavior as phishing events and improved security.

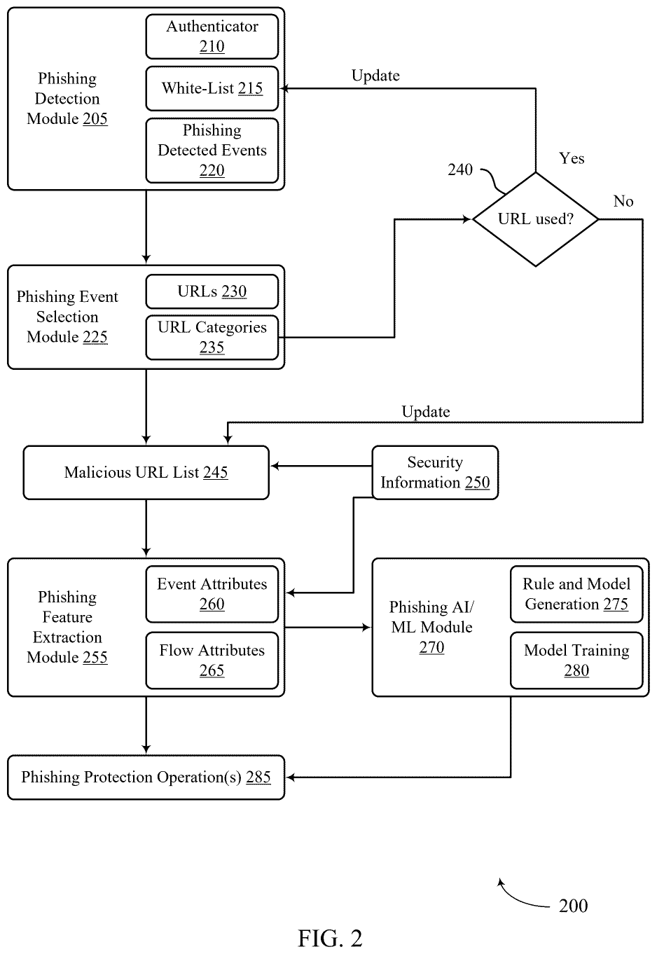

FIG. 2 shows an example of a security system 200 that supports phishing event detection in accordance with aspects of the present disclosure. In some examples, the security system 200 may implement or be implemented by aspects of the computing system 100. For example, the security system 200 may be an example of or include aspects of the identity management system 120 as described with reference to FIG. 1.

The security system 200 may include one or more modules that may be used to support phishing detection. The modules described herein may be understood to include further components or perform further functions not referenced in the example of FIG. 2. For example, the modules, and the security system 200, described with reference to FIG. 2 may be part of a network itself or some identity threat protection tool used by the network. In one example, the security system 200 may be an example of the identity management system 120 described with reference to FIG. 2, and the one or more modules may refer to parts or components of the identity management system 120.

A phishing detection module 205 of the security system 200 may implement or be implemented by an authenticator 210. For example, the authenticator 210 may receive or obtain incoming requests for resources that use credentials authenticated by the security system 200. The authenticator 210 may be a phishing-resistant authenticator. For example, the authenticator 210 may refrain from authenticating (e.g., reject) requests for access to URLs that are absent from a white-list 215. The phishing detection module 205 may store one or more white lists for one or more organizations that use the security system 200. The white-list 215 may be an example of a list of allowed or permitted URLs for an organization. That is, some user of the organization (e.g., an administrator) may include URLs in the white-list 215 that are used by the organization, the security system 200 may include some common URLs (e.g., by default) in the white-list 215, or the like. In some examples, the phishing detection module 205 may support passwordless login to URLs and phishing event logging.

The authenticator 210 may pass incoming requests for URLs that are absent from the white-list 215 to a set of phishing detected events 220. For example, the phishing detected events 220 may include information about requests for URLs that were not included in the white-list 215. These stored events may be queried by one or more other modules for phishing event attribute extraction. For example, the phishing event selection module 225 may query for events (e.g., user.authentication.auth_via_mfa events) including a risk field that indicates that the event included a URL that was absent from the white-list 215 (e.g., reasons=Mismatched request) and including an origin URL that is not null. An exemplary event may be {reasons=Mismatched request origin: https://oktosign.com-secure-logon.com; Application Name: okta_enduser, level=HIGH}.

The phishing event selection module 225 of the security system 200 may obtain URLs 230 that are mismatched. That is, the phishing event selection module 225 may extract, from the phishing detected events 220, URLs 230. As an example, from the event {reasons=Mismatched request origin: https://oktosign.com-secure-logon.com; Application Name: okta_enduser, level=HIGH}, the phishing event selection module 225 may extract “https://oktosign.com-secure-logon.com.” The URLs 230 may be URLs that users requested to access, but the requests were rejected by the authenticator 210 as being phishing events. The phishing event selection module 225 may categorize the URLs 230 into one or more categories. For example, the phishing event selection module 225 may categorize a URL as a white-list URL (e.g., update the white-list to include the URL) or a malicious URL (e.g., update the malicious URL list 245 to include the URL).

In some examples, the phishing event selection module 225 may categorize the URLs based on user input. For example, the security system 200 may, at 240, determine whether the URL is used by the organization, a red team of the organization, or both. Put another way, the phishing event selection module 225 may determine URL categories 235. The security system 200 may display, via a user interface, an indication of the URL and receive, in response to displaying the indication of the URL, an input indicating whether the URL is used by the organization. Based on determining whether the URL is used, the security system 200 may update the white-list 215 or a malicious URL list 245 to include the URL. In some examples, a URL used by the red team of the organization may be added to the white-list 215 or the malicious URL list 245, such as based on a security vulnerability that is targeted by the red team or testing parameters.

The phishing event selection module 225 may identify, from the URLs 230, phishing URLs. For example, the phishing event selection module 225 may identify phishing URLs from the URLs 230 according to a phishing URL naming convention, using a third-party phishing URL identification service, or both. Additionally, or alternatively, the security system 200 may implement a tool that flags newly created sites or URLs having a sign-in widget of the security system 200. Such a tool may flag potentially malicious URLs that target sign-ins for the security system 200 (e.g., attempt brand resemblance). In some examples, the phishing event selection module 225 may identify phishing events by first manually labeling URLs of phishing detected events 220 as phishing URLs or legitimate URLs, then by checking the labelling via the third-party URL identification service (e.g., by calling an API of the service). That is, the phishing event selection module 225 may identify “real” phishing events that were blocked by the authenticator 210 by filtering out events that are associated with legitimate URLs.

After identifying the phishing events from the phishing detected events 220 based on the event URLs, the security system 200 may extract attributes of the phishing events via a phishing feature extraction module 255. For example, the security system 200 may extract event attributes 260 and flow attributes 265 from the phishing events. The event attributes 260 may include features in the phishing events (e.g., malicious, declined phishing attempt events), including time stamps, URLs, IP addresses, organization identifiers (e.g., Organization_ID, such as an organization associated with a user whose credential is involved in the event), user identifiers (e.g., the user whose credential is involved in the event), actor identifiers (e.g., a user who is initiating the event, such as attempting to log in, which may be a different user than the user whose credential is involved), or the like. The flow attributes 265 may include features related to the flows in which the phishing events occur (e.g., malicious declined phishing attempt event flows), including factors used for the malicious logins (e.g., as part of MFA, such as one or more knowledge factors, one or more possession factors, or one or more inherence factors), user behaviors (e.g., time of access, location, click rate, resources accessed, etc.), IP addresses and devices involved in the flows, the application(s) that the user is attempting to access or has accessed during the session or in another recent session (e.g., within a threshold duration from the event flow), or the like. In some examples, the phishing feature extraction module 255 may compare “normal” flows (e.g., flows that are not identified as being malicious) to “abnormal” flows (e.g., flows that are identified as being malicious or phishing event flows). That is, the flow attributes 265 may represent absolute attributes or values, or deviations of attributes from some average flow for a user subject to the phishing attack or an organization.

The security system 200 may use the extracted event attributes 260 and the extracted flow attributes 265 at one or more models. For example, the security system 200 may use the extracted event attributes 260 and flow attributes 265 to fine-tune or develop one or more models, including models used for identity threat detection, such as identity threat protection models, identity security posture management, continuous session protection, or the like. That is, the extracted event attributes 260 and flow attributes 265 may be included in larger datasets (e.g., from previously extracted attributes, or attributes extracted from other types of malicious activity detected by the security system 200) used to train or develop identity threat detection models. As an example, the security system 200 may identify events having same IP addresses as phishing events in examples in which the IP addresses are not from proxies. By correlating with IP reputation data, tuning an IP flag time period, and identifying outlier cases, the security system 200 may flag or block activities as malicious. The security system 200 may also use flow identifiers (e.g., external_session_id) to identify flows related to the phishing events.

The security system 200 may directly use the extracted event attributes 260 and flow attributes 265 (e.g., at the phishing detection module 205). For example, the security system 200 may directly use the extracted event attributes 260 and flow attributes 265 to determine whether incoming requests have attributes similar to the event attributes 260 and flow attributes 265 extracted from phishing events. When incoming requests have similar attributes, the phishing detection module 205 may then identify the incoming requests as phishing events (e.g., without going through the phishing event selection module 225). That is, the incoming requests may be identified (e.g., immediately) as phishing events, blocked, and routed to the phishing feature extraction module 255.

Additionally, or alternatively, the security system 200 may use the extracted event attributes 260 and flow attributes 265 at the phishing AI/ML module 270. For example, the security system 200 may provide the extracted event attributes 260 and flow attributes 265 as input for rule and model generation 275, for model training 280, or both. That is, the security system 200 may use the event attributes 260 and flow attributes 265 as input to one or more models that generate, as output, security policies that identify phishing events (e.g., with improved accuracy compared to arbitrarily determined boundaries or thresholds). For example, the one or more models may generate heuristic rules to be applied at the phishing detection module 205. Additionally, or alternatively, the security system 200 may use the event attributes 260 and flow attributes 265 as positively labeled training data for one or more models. That is, the security system 200 may generate or train a model to identify phishing events based on attributes, and, to train the model, the security system 200 may provide the event attributes 260 and flow attributes 265 as positive examples of phishing events.

In some examples, the security system 200 may correlate the event attributes 260 and flow attributes 265 with other sources of information, such as security information 250. For example, the security system 200 may correlate the event attributes 260 and flow attributes 265 with the security information 250 to understand or identify phishing event flows across different users in a same organization, across organizations (e.g., served by the security system 200), or both. In some examples, the security system 200 may use the event attributes 260 and flow attributes 265 to identify phishing events for organizations that do not implement a phishing-resistant authenticator. That is, the security system 200 may update security policies (e.g., without implementing a phishing-resistant authenticator) to block phishing URLs, block incoming requests matching attributes of phishing events, or the like. In some examples, the security system 200 may use the event attributes 260 and flow attributes 265 to identify threat actors and create or enrich threat intelligence.

Because phishing events are associated with some level of success by the attacker (e.g., the attacker successfully caused a user to click on a malicious URL, had success with some credential, etc.), it may be likely that attackers associated with detected phishing events attempt subsequent phishing attempts at the organization or at other organizations served by the security system 200. Accordingly, by extracting the event attributes 260 and flow attributes 265, the security system 200 may improve phishing resistance to those attackers.

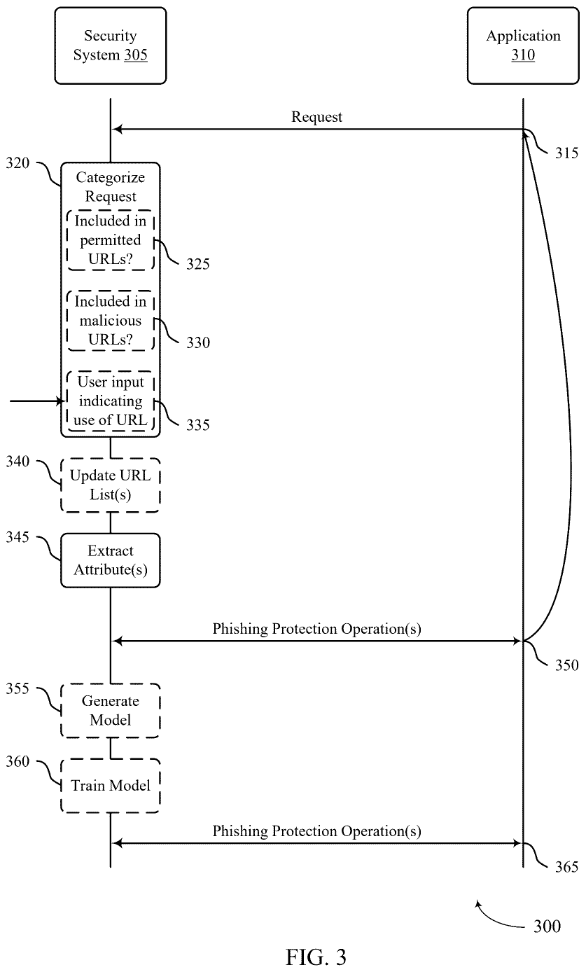

FIG. 3 shows an example of a process flow 300 that supports phishing event detection in accordance with aspects of the present disclosure. In some examples, the process flow 300 may implement aspects of the computing system 100, the security system 200, or both. The process flow 300 may illustrate operations of a security system 305, which may be an example of the security system 200 as described with reference to FIG. 2.

In the following description of the process flow 300, the operations performed at the security system 305 and the application 310 may be performed in different orders or at different times than shown. While the operations of the process flow 300 are illustrated and described as being performed by security system 305 and the application 310, the operations described herein may be performed at one or more other devices or systems. Additionally, or alternatively, some operations may be omitted from the process flow 300 and other operations may be added to the process flow 300.

At 315, the security system 305 may receive a request. For example, the security system 305 may receive a request to access a resource of a URL using a credential of a user of an organization. In some examples, the security system 305 may receive the request via the application 310. For example, the security system 305 may receive the request via an application or URL of the security system that supports input of credentials to access resources. The security system 305 may receive the request at a component or module of the security system 305, such as at an authenticator 210 or a phishing detection module 205 as described with reference to FIG. 2.

At 320, the security system 305 may categorize the request. For example, the security system 305 may categorize the request to access the resource of the URL as a phishing event. the security system 305 may categorize the request at a component or module of the security system 305, such as at the phishing event selection module 225 as described with reference to FIG. 2.

At 325, the security system 305 may determine whether the URL of the request is included in a list of permitted URLs. The list of permitted URLs may be an example of a white-list 215 as described with reference to FIG. 2. For example, the URL may be absent from a set of URLs permitted for the organization, and the request may be categorized as a phishing event based on the URL being absent from the set of URLs. In such examples, the security system 305 may continue to perform the operations of the process flow 300 to extract the features of the phishing event after categorizing the request. In another example, the URL may be included in a set of URLs permitted for the organization. In such examples, the security system 305 may process the request to access the resource of the URL after determining that the URL is included in the set of URLs.

At 330, the security system 305 may determine whether the URL of the request is included in a list of malicious URLs. The list of malicious URLs may be an example of the malicious URL list 245 as described with reference to FIG. 2. In some examples, the security system 305 may determine whether the URL is included in the list of malicious URLs after determining whether the URL is included in a list of permitted URLs at 325.

At 335, the security system 305 may receive a user input indicating use of a URL. For example, the security system 305 may determine (e.g., if a URL is not included on the list of permitted or malicious URLs) whether the URL is permitted or malicious based on user input. The user input may indicate whether the URL is used by the organization, a red team of the organization, or the like. Determination of whether the URL is used may be an example of the determination at 240 of FIG. 2.

At 340, the security system 305 may update the URL list(s). For example, according to the user input, the security system 305 may update the list of permitted URLs or the list of malicious URLs. Put another way, the security system 305 may update a set of malicious URLs to include the URL based on the user input, where extracting the one or more attributes from the phishing event is based on updating the set of malicious URLs to include the URL.

At 345, the security system 305 may extract attribute(s). For example, the security system 305 may extract one or more attributes from a phishing event based on categorizing the request as a phishing event. The security system 305 may extract the attribute(s) at a component or module of the security system 305, such as at the phishing feature extraction module 255 as described with reference to FIG. 2. The one or more attributes may include one or more phishing event attributes, one or more phishing flow attributes, or both. The one or more phishing event attributes may include one or more of a timestamp of the request, the URL, an IP address of a victim device (e.g., a user device) that transmitted the request, an IP address of a threat actor that performed the request, an identifier of the organization of the victim, an identifier of the victim, an identifier of the victim device or device agent information, or an identifier of the threat actor device or device agent information. The one or more phishing flow attributes may include one or more devices involved in a flow, one or more IP addresses involved in the flow, or both.

At 350, the security system 305 may perform phishing protection operation(s). Performance of the phishing protection operation(s) may be an example of the phishing protection operation(s) 285 as described with reference to FIG. 2. For example, the security system 305 may perform, in real-time, at least one first phishing protection operation that is in accordance with the extracted one or more attributes. Performing the at least one first phishing protection operation may include detecting one or more phishing events in accordance with one or more incoming requests received at the security system 305 (e.g., at or after 360), the one or more incoming requests having the one or more attributes extracted from the phishing event. In some examples, performing the at least one first phishing protection operation may include logging out victims of the phishing events (e.g., users whose credentials are used in the phishing events) in real-time from the security system 305 (e.g., an identity management system) and applications currently connected to the security system 305 for the user. Put another way, the security system 305 may log out the user who is targeted for the phishing event via the request at 315 based on the extracted one or more attributes. Logging out the user may include logging the user out from all applications accessible to the user via the security system 305 (e.g., ending session(s) for the user with applications).

At 355, the security system 305 may generate a model. The security system 305 may generate the model at a component or module of the security system, such as at the phishing AI/ML module 270 as described with reference to FIG. 2. For example, the security system 305 may generate the model of the security system using the extracted one or more attributes. The model may include an AI or ML model.

At 360, the security system 305 may train a model. The security system 305 may train the model at a component or module of the security system, such as at the phishing AI/ML module 270 as described with reference to FIG. 2. For example, the security system 305 may designate the one or more attributes (e.g., of the phishing event) as positive examples of phishing events and train the model of the security system 305 using the one or more attributes designated as positive examples of phishing events.

In examples in which the security system 305 generates or trains the model, the trained or generated model may be used to identify whether incoming requests are phishing events. For example, the phishing protection operation(s) at 365 may refer to or include application of the model that is trained or generated using the one or more attributes.

At 365, the security system 305 may perform phishing protection operation(s). Performance of the phishing protection operation(s) may be an example of the phishing protection operation(s) 285 as described with reference to FIG. 2. For example, the security system 305 may perform at least one second phishing protection operation that is in accordance with an output of a model of the security system that is trained using the one or more attributes. For example, the security system 305 may generate, via the model of the security system 305, one or more heuristic rules that define whether an event is a phishing event, where applying the at least one second phishing protection operation includes applying the one or more heuristic rules.

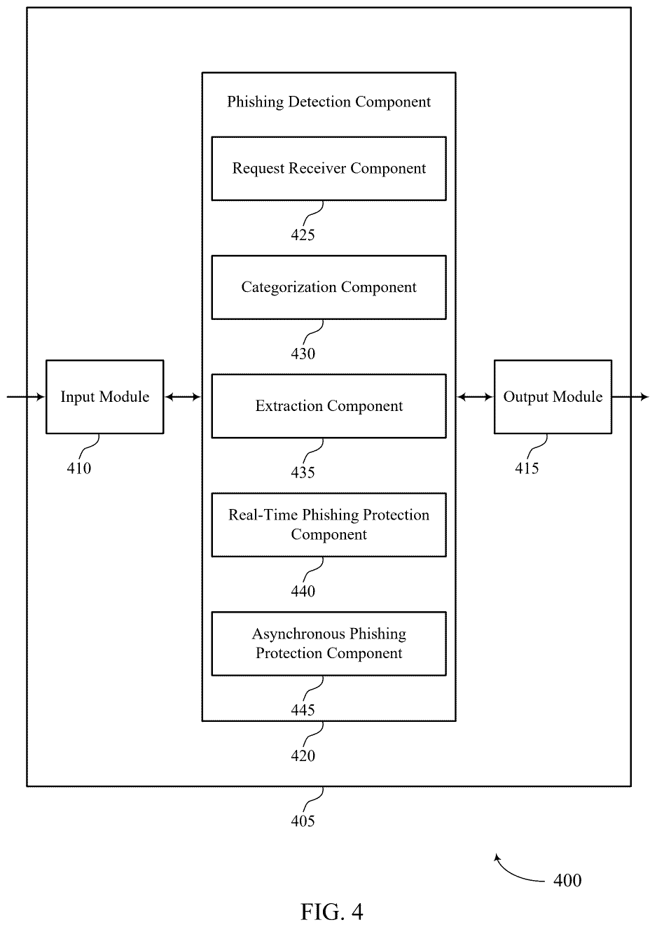

FIG. 4 shows a block diagram 400 of a device 405 that supports phishing event detection in accordance with aspects of the present disclosure. The device 405 may include an input module 410, an output module 415, and a phishing detection component 420. The device 405, or one or more components of the device 405 (e.g., the input module 410, the output module 415, the phishing detection component 420), may include at least one processor, which may be coupled with at least one memory, to support the described techniques. Each of these components may be in communication with one another (e.g., via one or more buses).

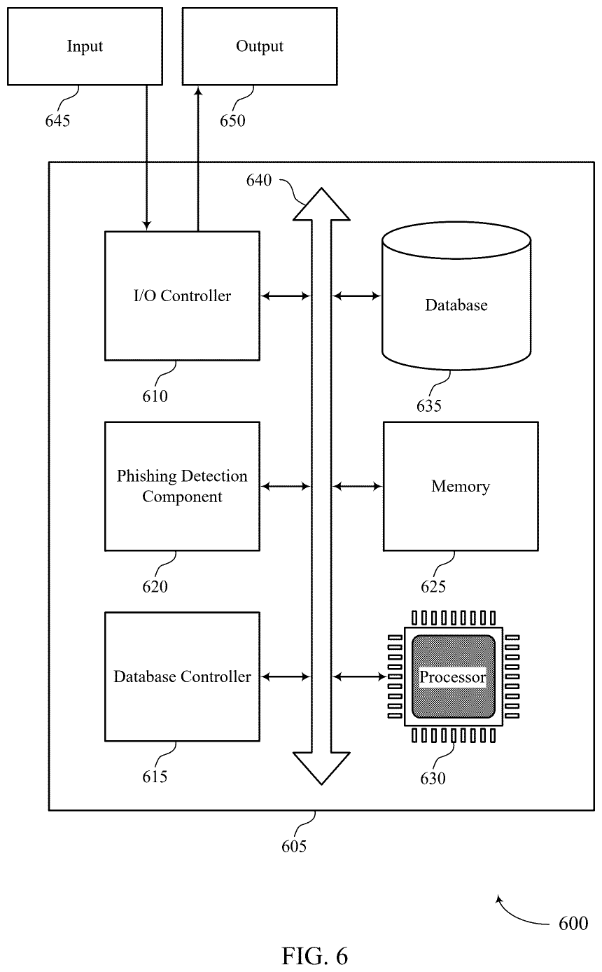

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the phishing detection component 420 to support phishing event detection. In some cases, the input module 410 may be a component of an input/output (I/O) controller 610 as described with reference to FIG. 6.

The output module 415 may manage output signals for the device 405. For example, the output module 415 may receive signals from other components of the device 405, such as the phishing detection component 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the phishing detection component 420 may include a request receiver component 425, a categorization component 430, an extraction component 435, a real-time phishing protection component 440, an asynchronous phishing protection component 445, or any combination thereof. In some examples, the phishing detection component 420, or various components thereof, may be configured to perform various operations (e.g., receiving, monitoring, transmitting) using or otherwise in cooperation with the input module 410, the output module 415, or both. For example, the phishing detection component 420 may receive information from the input module 410, send information to the output module 415, or be integrated in combination with the input module 410, the output module 415, or both to receive information, transmit information, or perform various other operations as described herein.

The phishing detection component 420 may support phishing event detection in accordance with examples as disclosed herein. The request receiver component 425 may be configured to support receiving, at a security system, a request to access a resource of a URL using a credential of a user of an organization. The categorization component 430 may be configured to support categorizing the request to access the resource of the URL as a phishing event. The extraction component 435 may be configured to support extracting one or more attributes from the phishing event based on categorizing the request as a phishing event. The real-time phishing protection component 440 may be configured to support performing, in real-time, at least one first phishing protection operation that is in accordance with the extracted one or more attributes. The asynchronous phishing protection component 445 may be configured to support performing at least one second phishing protection operation that is in accordance with an output of a model of the security system that is trained using the one or more attributes.

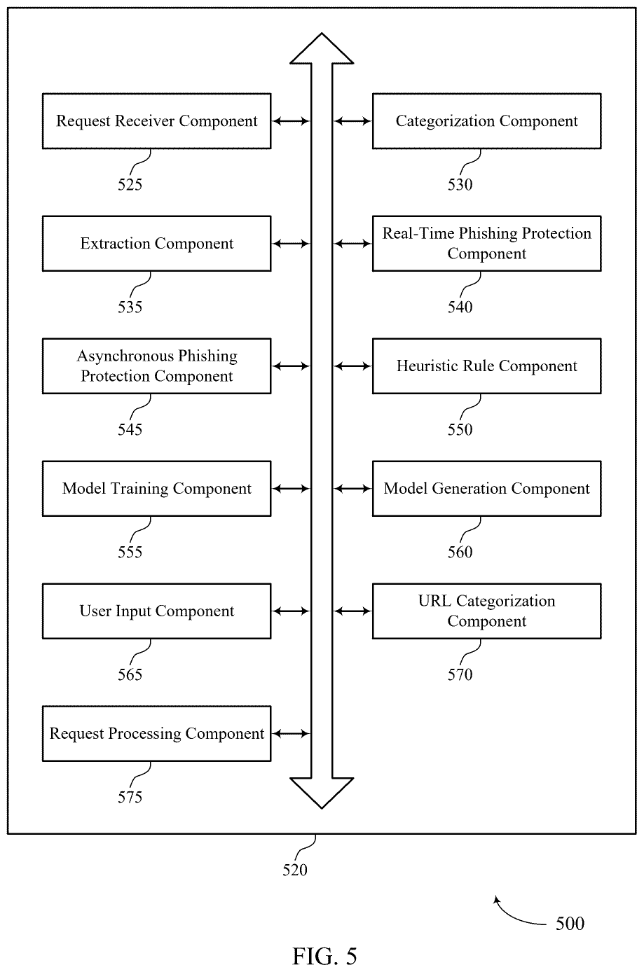

FIG. 5 shows a block diagram 500 of a phishing detection component 520 that supports phishing event detection in accordance with aspects of the present disclosure. The phishing detection component 520 may be an example of aspects of a phishing detection component or a phishing detection component 420, or both, as described herein. The phishing detection component 520, or various components thereof, may be an example of means for performing various aspects of phishing event detection as described herein. For example, the phishing detection component 520 may include a request receiver component 525, a categorization component 530, an extraction component 535, a real-time phishing protection component 540, an asynchronous phishing protection component 545, a heuristic rule component 550, a model training component 555, a model generation component 560, a user input component 565, an URL categorization component 570, a request processing component 575, or any combination thereof. Each of these components, or components of subcomponents thereof (e.g., one or more processors, one or more memories), may communicate, directly or indirectly, with one another (e.g., via one or more buses).

The phishing detection component 520 may support phishing event detection in accordance with examples as disclosed herein. The request receiver component 525 may be configured to support receiving, at a security system, a request to access a resource of a URL using a credential of a user of an organization. The categorization component 530 may be configured to support categorizing the request to access the resource of the URL as a phishing event. The extraction component 535 may be configured to support extracting one or more attributes from the phishing event based on categorizing the request as a phishing event. The real-time phishing protection component 540 may be configured to support performing, in real-time, at least one first phishing protection operation that is in accordance with the extracted one or more attributes. The asynchronous phishing protection component 545 may be configured to support performing at least one second phishing protection operation that is in accordance with an output of a model of the security system that is trained using the one or more attributes.

In some examples, the heuristic rule component 550 may be configured to support generating, via the model of the security system, one or more heuristic rules that define whether an event includes a phishing event, where applying the at least one second phishing protection operation includes applying the one or more heuristic rules.

In some examples, performing the at least one first phishing protection operation includes detecting one or more phishing events in accordance with one or more incoming requests received at the security system, the one or more incoming requests having the one or more attributes extracted from the phishing event.

In some examples, the extraction component 535 may be configured to support designating the one or more attributes as positive examples of phishing events. In some examples, the model training component 555 may be configured to support training the model of the security system using the one or more attributes designated as positive examples of phishing events.

In some examples, the model generation component 560 may be configured to support generating the model of the security system using the extracted one or more attributes.

In some examples, the URL is absent from a set of URLs permitted for the organization. In some examples, the request is categorized as the phishing event based on the URL being absent from the set of URLs.

In some examples, the user input component 565 may be configured to support receiving a user input indicating that the URL is unused by the organization, a security team, or both. In some examples, the URL categorization component 570 may be configured to support updating a set of malicious URLs to include the URL based on the user input, where extracting the one or more attributes from the phishing event is further based on updating the set of malicious URLs to include the URL.

In some examples, the request receiver component 525 may be configured to support receiving a second request to access a second resource of a second URL using the credential of the user of the organization.

In some examples, the URL categorization component 570 may be configured to support determining that the second URL is included in a set of URLs permitted for the organization. In some examples, the request processing component 575 may be configured to support processing the second request to access the second resource of the second URL after determining that the second URL is included in the set of URLs.

In some examples, the URL categorization component 570 may be configured to support determining that the second URL is absent from a set of URLs permitted for the organization. In some examples, the user input component 565 may be configured to support receiving a user input indicating that the second URL is used by the organization, a security team, or both. In some examples, the URL categorization component 570 may be configured to support updating the set of URLs permitted for the organization to include the second URL.

In some examples, the one or more phishing event attributes include one or more of a timestamp of the request, the URL, an IP address of a user device that transmitted the request, an identifier of the organization, an identifier of the user, or an identifier of an actor, and the one or more phishing flow attributes include one or more devices involved in a flow, one or more IP addresses involved in the flow, or both.

In some examples, the model includes an AI or ML model.

FIG. 6 shows a diagram of a system 600 including a device 605 that supports phishing event detection in accordance with aspects of the present disclosure. The device 605 may be an example of or include components of a device 405 as described herein. The device 605 may include components for bi-directional voice and data communications including components for transmitting and receiving communications, such as a phishing detection component 620, an I/O controller, such as an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting phishing event detection). The processor 630 may be an example of a single processor or multiple processors. For example, the device 605 may include one or more processors 630.

The phishing detection component 620 may support phishing event detection in accordance with examples as disclosed herein. For example, the phishing detection component 620 may be configured to support receiving, at a security system, a request to access a resource of a URL using a credential of a user of an organization. The phishing detection component 620 may be configured to support categorizing the request to access the resource of the URL as a phishing event. The phishing detection component 620 may be configured to support extracting one or more attributes from the phishing event based on categorizing the request as a phishing event. The phishing detection component 620 may be configured to support performing, in real-time, at least one first phishing protection operation that is in accordance with the extracted one or more attributes. The phishing detection component 620 may be configured to support performing at least one second phishing protection operation that is in accordance with an output of a model of the security system that is trained using the one or more attributes.

By including or configuring the phishing detection component 620 in accordance with examples as described herein, the device 605 may support techniques for improved detection of phishing events and, accordingly, improved network security.

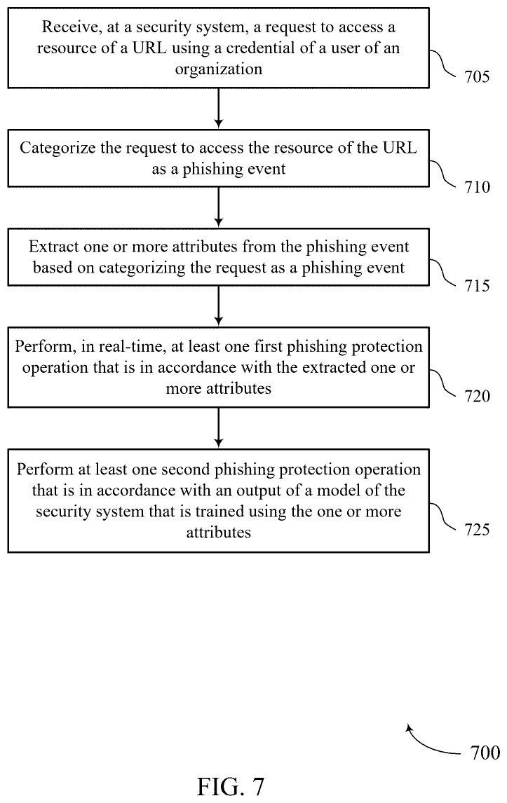

FIG. 7 shows a flowchart illustrating a method 700 that supports phishing event detection in accordance with aspects of the present disclosure. The operations of the method 700 may be implemented by an Okta Device or its components as described herein. For example, the operations of the method 700 may be performed by an Okta Device as described with reference to FIGS. 1 through 6. In some examples, an Okta Device may execute a set of instructions to control the functional elements of the Okta Device to perform the described functions. Additionally, or alternatively, the Okta Device may perform aspects of the described functions using special-purpose hardware.

At 705, the method may include receiving, at a security system, a request to access a resource of a URL using a credential of a user of an organization. The operations of 705 may be performed in accordance with examples as disclosed herein. In some examples, aspects of the operations of 705 may be performed by a request receiver component 525 as described with reference to FIG. 5.

At 710, the method may include categorizing the request to access the resource of the URL as a phishing event. The operations of 710 may be performed in accordance with examples as disclosed herein. In some examples, aspects of the operations of 710 may be performed by a categorization component 530 as described with reference to FIG. 5.

At 715, the method may include extracting one or more attributes from the phishing event based on categorizing the request as a phishing event. The operations of 715 may be performed in accordance with examples as disclosed herein. In some examples, aspects of the operations of 715 may be performed by an extraction component 535 as described with reference to FIG. 5.

At 720, the method may include performing, in real-time, at least one first phishing protection operation that is in accordance with the extracted one or more attributes. The operations of 720 may be performed in accordance with examples as disclosed herein. In some examples, aspects of the operations of 720 may be performed by a real-time phishing protection component 540 as described with reference to FIG. 5.

At 725, the method may include performing at least one second phishing protection operation that is in accordance with an output of a model of the security system that is trained using the one or more attributes. The operations of 725 may be performed in accordance with examples as disclosed herein. In some examples, aspects of the operations of 725 may be performed by an asynchronous phishing protection component 545 as described with reference to FIG. 5.

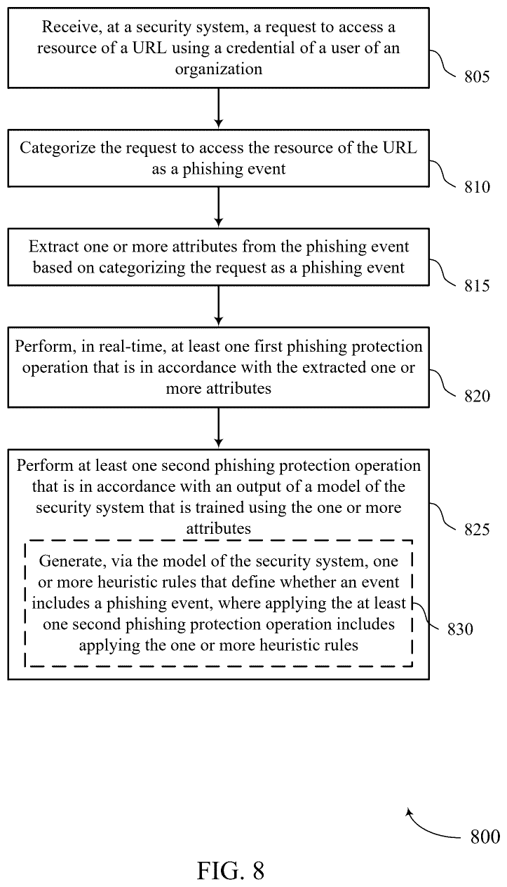

FIG. 8 shows a flowchart illustrating a method 800 that supports phishing event detection in accordance with aspects of the present disclosure. The operations of the method 800 may be implemented by an Okta Device or its components as described herein. For example, the operations of the method 800 may be performed by an Okta Device as described with reference to FIGS. 1 through 6. In some examples, an Okta Device may execute a set of instructions to control the functional elements of the Okta Device to perform the described functions. Additionally, or alternatively, the Okta Device may perform aspects of the described functions using special-purpose hardware.

At 805, the method may include receiving, at a security system, a request to access a resource of a URL using a credential of a user of an organization. The operations of 805 may be performed in accordance with examples as disclosed herein. In some examples, aspects of the operations of 805 may be performed by a request receiver component 525 as described with reference to FIG. 5.

At 810, the method may include categorizing the request to access the resource of the URL as a phishing event. The operations of 810 may be performed in accordance with examples as disclosed herein. In some examples, aspects of the operations of 810 may be performed by a categorization component 530 as described with reference to FIG. 5.

At 815, the method may include extracting one or more attributes from the phishing event based on categorizing the request as a phishing event. The operations of 815 may be performed in accordance with examples as disclosed herein. In some examples, aspects of the operations of 815 may be performed by an extraction component 535 as described with reference to FIG. 5.

At 820, the method may include performing, in real-time, at least one first phishing protection operation that is in accordance with the extracted one or more attributes. The operations of 820 may be performed in accordance with examples as disclosed herein. In some examples, aspects of the operations of 820 may be performed by a real-time phishing protection component 540 as described with reference to FIG. 5.

At 825, the method may include performing at least one second phishing protection operation that is in accordance with an output of a model of the security system that is trained using the one or more attributes. The operations of 825 may be performed in accordance with examples as disclosed herein. In some examples, aspects of the operations of 825 may be performed by an asynchronous phishing protection component 545 as described with reference to FIG. 5.

In some examples, performing the at least one second phishing protection operation may include, at 830, generating, via the model of the security system, one or more heuristic rules that define whether an event includes a phishing event, where applying the at least one second phishing protection operation includes applying the one or more heuristic rules. The operations of 830 may be performed in accordance with examples as disclosed herein. In some examples, aspects of the operations of 830 may be performed by a heuristic rule component 550 as described with reference to FIG. 5.

The following provides an overview of aspects of the present disclosure:
Aspect 1: A method for phishing event detection, comprising: receiving, at a security system, a request to access a resource of a URL using a credential of a user of an organization; categorizing the request to access the resource of the URL as a phishing event; extracting one or more attributes from the phishing event based at least in part on categorizing the request as a phishing event; performing, in real-time, at least one first phishing protection operation that is in accordance with the extracted one or more attributes; and performing at least one second phishing protection operation that is in accordance with an output of a model of the security system that is trained using the one or more attributes.
Aspect 2: The method of aspect 1, further comprising: generating, via the model of the security system, one or more heuristic rules that define whether an event comprises a phishing event, wherein applying the at least one second phishing protection operation comprises applying the one or more heuristic rules.
Aspect 3: The method of any of aspects 1 through 2, wherein performing the at least one first phishing protection operation comprises detecting one or more phishing events in accordance with one or more incoming requests received at the security system, the one or more incoming requests having the one or more attributes extracted from the phishing event.
Aspect 4: The method of any of aspects 1 through 3, further comprising: designating the one or more attributes as positive examples of phishing events; and training the model of the security system using the one or more attributes designated as positive examples of phishing events.
Aspect 5: The method of any of aspects 1 through 4, further comprising: generating the model of the security system using the extracted one or more attributes.
Aspect 6: The method of any of aspects 1 through 5, wherein the URL is absent from a set of URLs permitted for the organization, and the request is categorized as the phishing event based at least in part on the URL being absent from the set of URLs.
Aspect 7: The method of any of aspects 1 through 6, further comprising: receiving a user input indicating that the URL is unused by the organization, a security team, or both; and updating a set of malicious URLs to include the URL based at least in part on the user input, wherein extracting the one or more attributes from the phishing event is further based at least in part on updating the set of malicious URLs to include the URL.
Aspect 8: The method of any of aspects 1 through 7, further comprising: receiving a second request to access a second resource of a second URL using the credential of the user of the organization.
Aspect 9: The method of aspect 8, further comprising: determining that the second URL is included in a set of URLs permitted for the organization; and processing the second request to access the second resource of the second URL after determining that the second URL is included in the set of URLs.
Aspect 10: The method of any of aspects 8 through 9, further comprising: determining that the second URL is absent from a set of URLs permitted for the organization; receiving a user input indicating that the second URL is used by the organization, a security team, or both; and updating the set of URLs permitted for the organization to include the second URL.
Aspect 11: The method of any of aspects 1 through 10, wherein the one or more attributes comprise one or more phishing event attributes, one or more phishing flow attributes, or both, and wherein the one or more phishing event attributes comprise one or more of a timestamp of the request, the URL, an IP address of a user device that transmitted the request, an identifier of the organization, an identifier of the user, or an identifier of an actor, and the one or more phishing flow attributes comprise one or more devices involved in a flow, one or more IP addresses involved in the flow, or both.
Aspect 12: The method of any of aspects 1 through 11, wherein the model comprises an AI or ML model.
Aspect 13: An apparatus for phishing event detection, comprising one or more memories storing processor-executable code, and one or more processors coupled with the one or more memories and individually or collectively operable to execute the code to cause the apparatus to perform a method of any of aspects 1 through 12.
Aspect 14: An apparatus for phishing event detection, comprising at least one means for performing a method of any of aspects 1 through 12.
Aspect 15: A non-transitory computer-readable medium storing code for phishing event detection, the code comprising instructions executable by one or more processors to perform a method of any of aspects 1 through 12.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for phishing event detection, comprising:
receiving, at a security system, a request to access a resource of a uniform resource locator (URL) using a credential of a user of an organization;
categorizing the request to access the resource of the URL as a phishing event;
extracting one or more attributes from the phishing event based at least in part on categorizing the request as the phishing event;
performing, in real-time, at least one first phishing protection operation that is in accordance with the extracted one or more attributes; and
performing at least one second phishing protection operation that is in accordance with an output of a model of the security system that is trained using the one or more attributes.

2. The method of claim 1, further comprising:
generating, via the model of the security system, one or more heuristic rules that define whether an event comprises a phishing event, wherein applying the at least one second phishing protection operation comprises applying the one or more heuristic rules.

3. The method of claim 1, wherein performing the at least one first phishing protection operation comprises detecting one or more phishing events in accordance with one or more incoming requests received at the security system, the one or more incoming requests having the one or more attributes extracted from the phishing event.

4. The method of claim 1, further comprising:
designating the one or more attributes as positive examples of phishing events; and
training the model of the security system using the one or more attributes designated as positive examples of phishing events.

5. The method of claim 1, further comprising:
generating the model of the security system using the extracted one or more attributes.

6. The method of claim 1, wherein:
the URL is absent from a set of URLs permitted for the organization, and
the request is categorized as the phishing event based at least in part on the URL being absent from the set of URLs.

7. The method of claim 1, further comprising:
receiving a user input indicating that the URL is unused by the organization, a security team, or both; and
updating a set of malicious URLs to include the URL based at least in part on the user input, wherein extracting the one or more attributes from the phishing event is further based at least in part on updating the set of malicious URLs to include the URL.

8. The method of claim 1, further comprising:
receiving a second request to access a second resource of a second URL using the credential of the user of the organization.

9. The method of claim 8, further comprising:
determining that the second URL is included in a set of URLs permitted for the organization; and
processing the second request to access the second resource of the second URL after determining that the second URL is included in the set of URLs.

10. The method of claim 8, further comprising:
determining that the second URL is absent from a set of URLs permitted for the organization;
receiving a user input indicating that the second URL is used by the organization, a security team, or both; and
updating the set of URLs permitted for the organization to include the second URL.

11. The method of claim 1, wherein the one or more attributes comprise one or more phishing event attributes, one or more phishing flow attributes, or both, and wherein the one or more phishing event attributes comprise one or more of a timestamp of the request, the URL, an internet protocol (IP) address of a user device that transmitted the request, an identifier of the organization of the user, an IP address of a threat actor that performed the request, an identifier of the user, an identifier of the threat actor that performed the request, an identifier of the user device, an identifier of a device of the threat actor, information of the user, or information of the threat actor, and the one or more phishing flow attributes comprise one or more devices involved in a flow, one or more IP addresses involved in the flow, or both.

12. The method of claim 1, wherein the model comprises an artificial intelligence (AI) or machine learning (ML) model.

13. An apparatus for phishing event detection, comprising:
one or more memories storing processor-executable code; and
one or more processors coupled with the one or more memories and individually or collectively operable to execute the code to cause the apparatus to:
receive, at a security system, a request to access a resource of a uniform resource locator (URL) using a credential of a user of an organization;
categorize the request to access the resource of the URL as a phishing event;
extract one or more attributes from the phishing event based at least in part on categorizing the request as the phishing event;
perform, in real-time, at least one first phishing protection operation that is in accordance with the extracted one or more attributes; and
perform at least one second phishing protection operation that is in accordance with an output of a model of the security system that is trained using the one or more attributes.

14. The apparatus of claim 13, wherein the one or more processors are individually or collectively further operable to execute the code to cause the apparatus to:
generate, via the model of the security system, one or more heuristic rules that define whether an event comprises a phishing event, wherein applying the at least one second phishing protection operation comprises applying the one or more heuristic rules.

15. The apparatus of claim 13, wherein performing the at least one first phishing protection operation comprises detecting one or more phishing events in accordance with one or more incoming requests received at the security system, the one or more incoming requests having the one or more attributes extracted from the phishing event.

16. The apparatus of claim 13, wherein the one or more processors are individually or collectively further operable to execute the code to cause the apparatus to:
designate the one or more attributes as positive examples of phishing events; and
train the model of the security system using the one or more attributes designated as positive examples of phishing events.

17. The apparatus of claim 13, wherein the one or more processors are individually or collectively further operable to execute the code to cause the apparatus to:
generate the model of the security system using the extracted one or more attributes.

18. The apparatus of claim 13, wherein:
the URL is absent from a set of URLs permitted for the organization, and
the request is categorized as the phishing event based at least in part on the URL being absent from the set of URLs.

19. A non-transitory computer-readable medium storing code for phishing event detection, the code comprising instructions executable by one or more processors to:
receive, at a security system, a request to access a resource of a uniform resource locator (URL) using a credential of a user of an organization;
categorize the request to access the resource of the URL as a phishing event;
extract one or more attributes from the phishing event based at least in part on categorizing the request as the phishing event;
perform, in real-time, at least one first phishing protection operation that is in accordance with the extracted one or more attributes; and
perform at least one second phishing protection operation that is in accordance with an output of a model of the security system that is trained using the one or more attributes.

20. The non-transitory computer-readable medium of claim 19, wherein the instructions are further executable by the one or more processors to:
generate, via the model of the security system, one or more heuristic rules that define whether an event comprises a phishing event, wherein applying the at least one second phishing protection operation comprises applying the one or more heuristic rules.
